(19) United States
(12) Patent Application Publication
(10) Pub. No.: US 2015/0294646 A1
(43) Pub. Date: Oct. 15, 2015

(54) DISPLAY APPARATUS AND METHOD FOR DISPLAYING SCREEN IMAGES FROM MULTIPLE ELECTRONIC DEVICES

(71) Applicant: HON HAI PRECISION INDUSTRY CO., LTD., New Taipei (TW)

(72) Inventors: Wen-Chia LEE, New Taipei (TW); Chuan-Te CHAN, New Taipei (TW); Sheng-Feng WENG, New Taipei (TW)

(21) Appl. No.: 14/677,247

(22) Filed: Apr. 2, 2015

(30) Foreign Application Priority Data
Apr. 9, 2014 (TW) 103112950

(51) Int. Cl. G09G 5/14; G09G 5/12; G06F 3/14

(52) U.S. Cl. CPC G09G 5/14; G06F 3/1454; G09G 5/12; G09G 2354/00; G09G 2370/16; G09G 2370/22; G09G 2370/20; G09G 2340/04; G09G 2320/08; G09G 2320/10

(57) ABSTRACT

A method for displaying screen images from multiple electronic devices using a display apparatus, the display apparatus includes a display screen and a connection device. The method includes establishing connections between the connection device and two or more of the multiple electronic devices when the connection device receives connection requests from two or more of the multiple electronic devices, and controlling the connection device to receive screen image signals sent from the connected two or more electronic devices. The method further includes generating a number of display windows on a display area of the display screen, associating each of the connected two or more electronic devices with one of the plurality of generated display windows, and displaying screen images generated from the display image signals sent from each of the connected two or more electronic devices in the display windows associated with the connected two or more electronic devices.

### CROSS-REFERENCE TO RELATED APPLICATIONS

This application claims priority to Taiwanese Patent Application No. 103112950 filed on Apr. 9, 2014, the contents of which are incorporated by reference herein.

### FIELD

The subject matter herein generally relates to display technology, and particularly to a display apparatus and a method for displaying screen images from multiple electronic devices based on wireless transmission technology.

### BACKGROUND

Existing display apparatus receives and displays screen images of multiple electronic devices by wires connecting to the multiple electronic devices. However, the display apparatus and the electronic devices are restrained by wires.

### BRIEF DESCRIPTION OF THE DRAWINGS

Implementations of the present disclosure will now be described, by way of example only, with reference to the attached figures.

FIG. 1 is a diagrammatic view of an example embodiment of multiple electronic devices being wirelessly connected to a single display apparatus.

FIG. 2 is a block diagram of an example embodiment of the display apparatus and the electronic devices of FIG. 1.

FIG. 3 is a block diagram of an example embodiment of a connection device of the display apparatus of FIG. 2.

FIG. 4 is a diagrammatic view of another example embodiment of multiple electronic devices being wirelessly connected to a display apparatus.

FIG. 5 is a block diagram of an example embodiment of a display system of the display apparatus of FIG. 2.

FIG. 6 shows a diagrammatic view of an example of a display interface of the display apparatus of FIG. 2.

FIG. 7 shows a diagrammatic view of another example of a display interface of the display apparatus of FIG. 2.

FIG. 8 is a flowchart of an example embodiment of a method for displaying screen images from multiple electronic devices.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts can be exaggerated to better illustrate details and features of the present disclosure.

Several definitions that apply throughout this disclosure will now be presented.

The term “comprising” means “including, but not necessarily limited to”; it specifically indicates open-ended inclusion or membership in a so-described combination, group, series, and the like. The term “module” refers to logic embodied in hardware or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

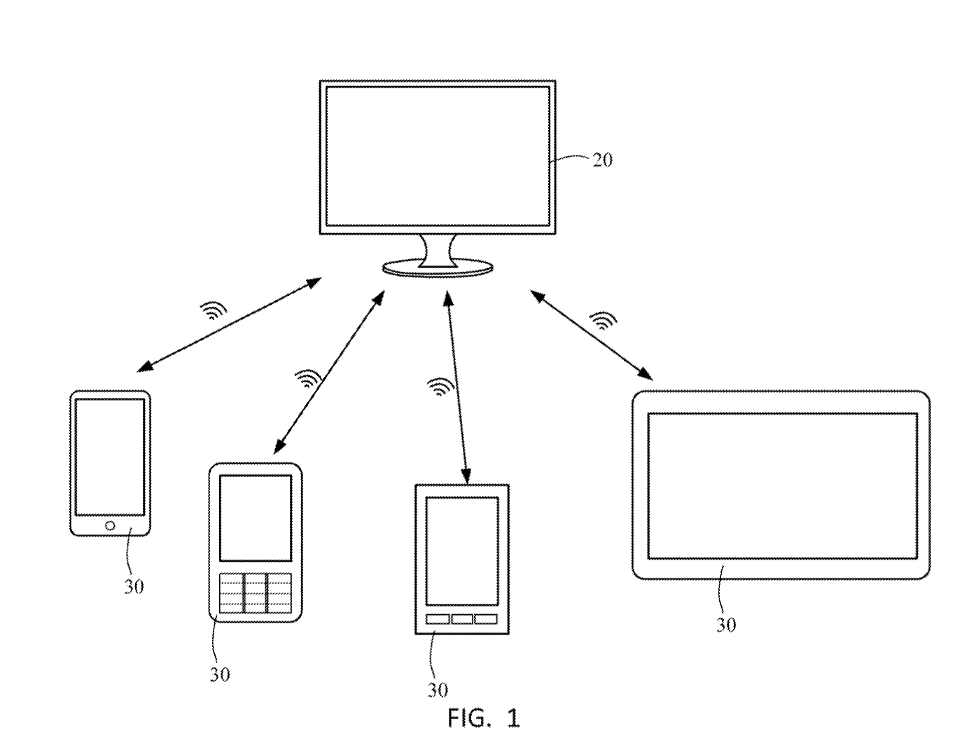

FIG. 1 is a diagrammatic view of an example embodiment of multiple electronic devices 30 being wirelessly connected to a display apparatus 20. Each of the multiple electronic devices 30 can be a portable device such as mobile phone, a tablet computer, a personal digital assistant (PDA), a personal computer, or any other suitable electronic device. The display apparatus 20 can be multimedia displayers, televisions, projectors, or any other display apparatuses which can receive external screen image signals and display screen images generated from the display image signals.

In one embodiment, the display apparatus 20 can receive screen image signals sent from the multiple electronic devices 30 and display screen images of the multiple electronic devices 30. In one embodiment, the display apparatus 20 can receive and display the screen images of the multiple electronic devices 30 using, e.g., INTEL WIDI technology, Apple AIRPLAY technology, MIRACAST technology, or any other technology known to one of ordinary skill in the art.

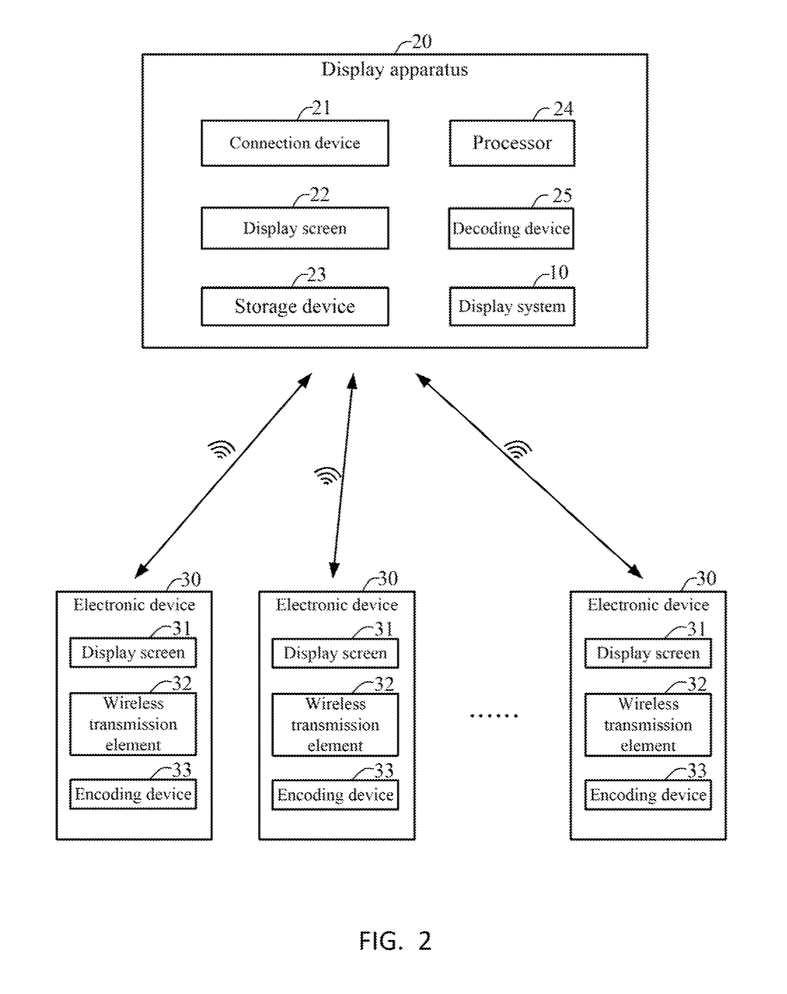

FIG. 2 is a block diagram of an example embodiment of the display apparatus 20 and the electronic devices 30. In at least one embodiment, each of the electronic devices 30 includes a display screen 31 and a wireless transmission element 32. The wireless transmission element 32 is wirelessly connected to the display apparatus 20, and sends screen image signals of the display screen 31 to the display apparatus 20. FIG. 2 illustrates only one example of the electronic devices 30, and other examples can comprise more or fewer components then shown in the embodiment, or have a different configuration of the various components.

In at least one embodiment, the display apparatus 20 includes a display system 10, a connection device 21, a display screen 22, a storage device 23, and at least one processor 24. FIG. 2 illustrates only one example of the display apparatus 20, and other examples can comprise more or fewer components than as shown in the embodiment, or have a different configuration of the various components.

The connection device 21 is connected to the display screen 22 and is connectable to the multiple electronic devices 30. In at least one embodiment, the connection device 21 is a wireless communication device.

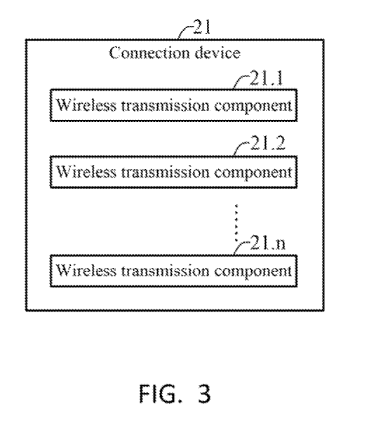

FIG. 3 shows in a first embodiment that the connection device 21 includes a plurality of wireless transmission components 21.1˜21.n which are capable of transmitting and receiving different types of wireless signals. Each of the wireless transmission components 21.1˜21.n are configured to communicate with one or more electronic devices 30 which are capable of transmitting the same type of wireless signal.

In the first embodiment, the wireless transmission components 21.1˜21.n can be hardware modules using e.g., WI-FI technology, BT technology, WHDI technology, WIHD technology, or any other technology known to one of ordinary skill in the art. Therefore, as shown in FIG. 1, the multiple electronic devices 30 which transmit different types of wireless signals can be directly connected to the display apparatus 20 through the wireless transmission components 21.1˜21.n.

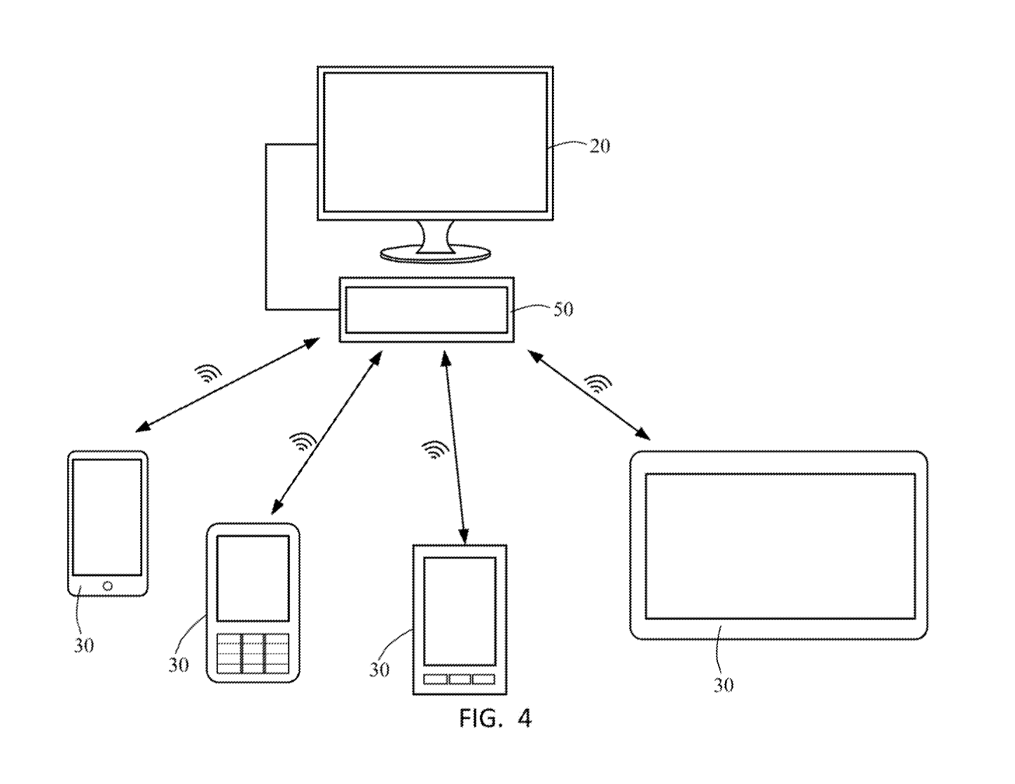

FIG. 4 shows in a second embodiment that the multiple electronic devices 30 can be wirelessly connected to the display apparatus 20 through an Access Point (AP) 50, such as a WI-FI AP, or any other Access Points known to one of ordinary skill in the art.

In one embodiment, each of the electronic devices 30 can further include an encoding device 33 which is configured to encode the screen image signals before the screen image signals are sent to the display apparatus 20. Correspondingly, the display apparatus 20 can further include a decoding device 25 which is configured to decode the encoded screen image signals sent from the multiple electronic devices 30.

The storage device 23 can be an internal storage device, such as a flash memory, a random access memory (RAM) for temporary storage of information, and/or a read-only memory (ROM) for permanent storage of information. The storage device 23 can also be an external storage device, such as an external hard disk, a storage card, or a data storage medium. The at least one processor 24 can be a central processing unit (CPU), a microprocessor, or other data processor chip that performs functions of the display apparatus 20.

The display system 10 can receipt connection requests from the multiple electronic devices 30 and receive screen image signals from the multiple electronic devices 30, and control the display screen 22 of the display apparatus 20 to display the screen images of the multiple electronic devices 30.

Therefore, the electronic devices 30 can be free to establish connections with the display apparatus 20 at any time to show screen image on the display apparatus 20, and also be free to break off a connection at any time, without reference to any wires or distance between each of the electronic devices 30 and the display apparatus 20.

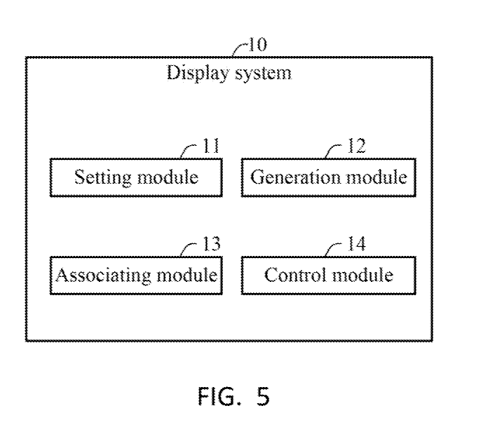

FIG. 5 shows that in one embodiment, the display system 10 includes a setting module 11, a generation module 12, an associating module 13, and a control module 14. Modules 11-14 can comprise computerized instructions in the form of one or more computer-readable programs that can be stored in a non-transitory computer-readable medium, for example in the storage device 23, and are executed by the at least one processor 24 of the display apparatus 20 to provide functions of the present disclosure. A detailed description of the functions of the modules 11-14 is given below in reference to FIG. 5.

In one embodiment, the setting module 11 can establish connections between the connection device 21 and two or more of the multiple electronic devices 30 when the connection device 21 receives connection requests from two or more of the multiple electronic devices 30. Such that, the control module 14 can control the connection device 21 to receive screen image signals sent from the connected two or more electronic devices 30.

In one embodiment, the setting module 11 can establish wireless connections between the two or more of the multiple electronic devices 30 and the wireless transmission components 21.1˜21.n according to the signal types of the connection requests.

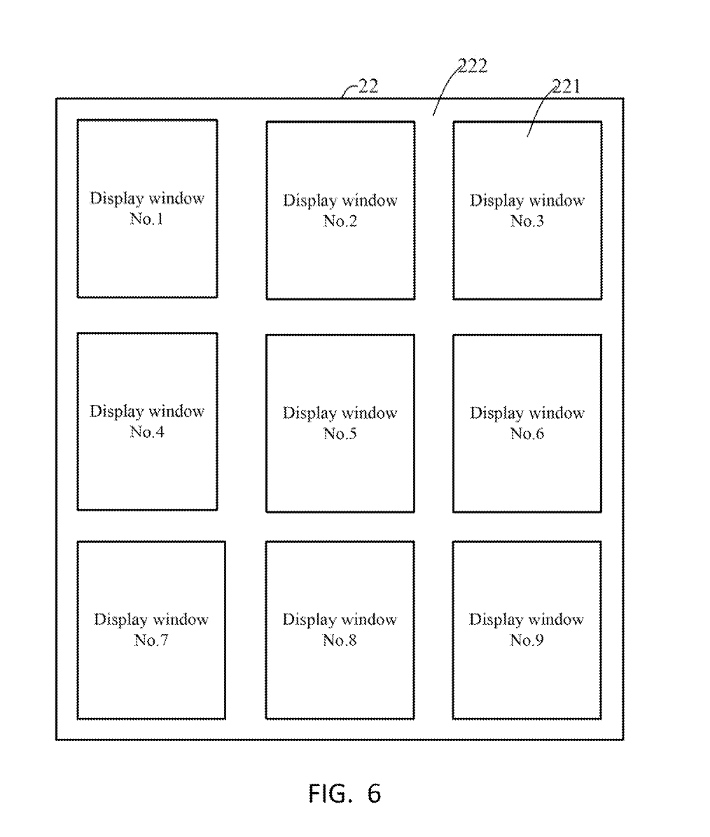

FIG. 6 shows that the generation module 12 can generate a number of display windows 221 on a display area 222 of the display screen 22.

In one embodiment, the generation module 12 can determine the total of the generated display windows 221 based on the total of the connected electronic devices 30. In other embodiments, the generation module 12 can determine the total of the generated display windows 221 based on an input number which can be input by users in a setting interface (not shown) of the display screen 22.

The associating module 13 can associate each of the connected two or more electronic devices 30 with one of the number of generated display windows 221.

FIG. 6 further shows that the control module 14 can control the display screen 22 of the display apparatus 20 to display screen images generated from the display image signals sent from each of the connected two or more electronic devices 30 in the generated display windows 221 associated with each of the connected two or more electronic devices 30.

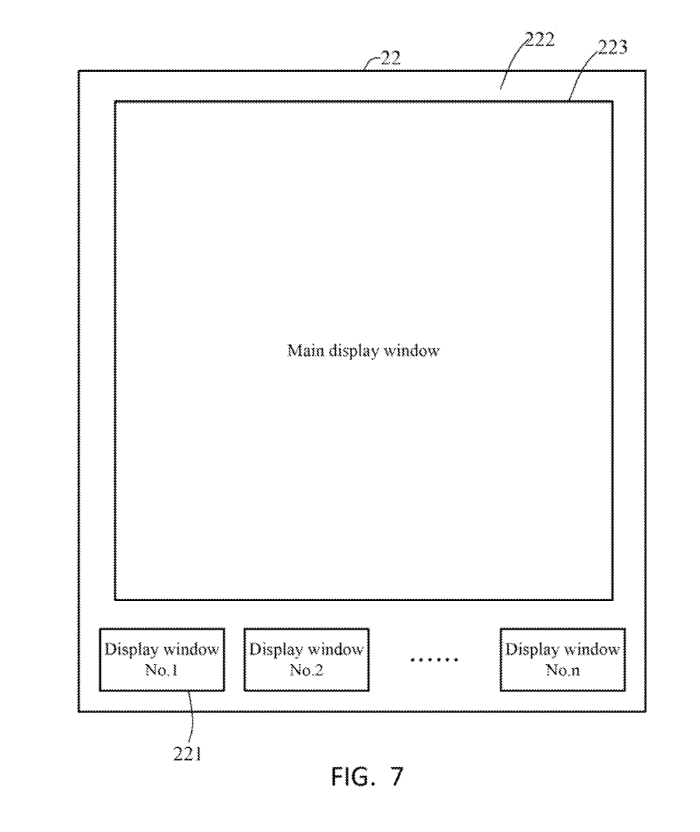

The control module 14 can further adjust display styles of the generated display windows 221 in response to user's operation on the generated display windows 221 and user instructions input through an input device (not shown) of the display apparatus 20 or sent from one of the connected electronic device 30. For example, when one of the generated display windows is selected by user and a full-screen display instruction is received, the control module 14 enlarges the selected display window to cover the whole display area of the display screen 22, and minimizes or hides the other generated display windows. As shown in FIG. 7, when one of the generated display windows is selected by user and an enlarged display instruction is received, the control module 14 reduces all of the generated display windows, and generates a main display window 223 covering most of the display area 222 of the display screen 22, which is configured to display the screen image in the selected display window.

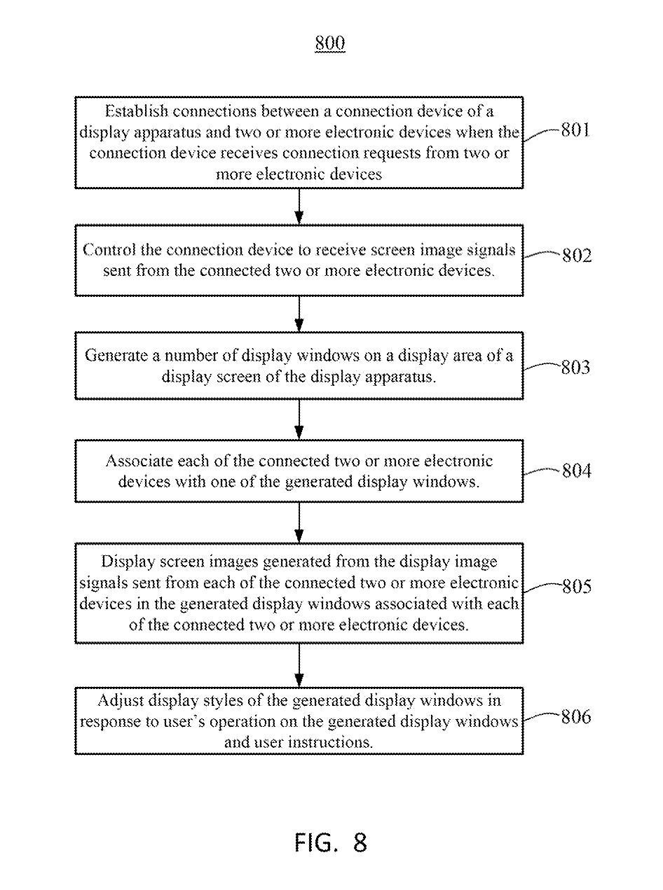

FIG. 8 illustrates a flowchart of an example embodiment of a method 800 for displaying screen images from multiple electronic devices using a display apparatus. In an example embodiment, the method 800 is performed by execution of computer-readable software program codes or instructions by at least one processor 24 of the display apparatus 20.

Referring to FIG. 8, a flowchart is presented in accordance with an example embodiment which is being thus illustrated. The example method 800 is provided by way of example, as there are a variety of ways to carry out the method. The method 800 described below can be carried out using the configurations illustrated in FIG. 3, for example, and various elements of these figures are referenced in explaining method 800. Each block shown in FIG. 8 represents one or more processes, methods, or subroutines, carried out in the exemplary method 800. Furthermore, the illustrated order of blocks is by example only and the order of the blocks can change according to the present disclosure. Additional blocks can be added or fewer blocks can be utilized, without departing from this disclosure. The example method 800 can begin at block 801.

At block 801, a setting module establishes connections between a connection device of the display apparatus and two or more of the multiple electronic devices when the connection device receives connection requests from two or more of the multiple electronic devices.

At block 802, a control module controls the connection device to receive screen image signals sent from the connected two or more electronic devices.

At block 803, a generation module generates a number of display windows on a display area of a display screen of the display apparatus.

In one embodiment, the generation module can determine the total of the generated display windows based on the total of connected electronic devices. In other embodiments, the generation module can determine the total of the generated display windows based on an input number which can be input by users in a setting interface of the display screen.

At block 804, an associating module associates each of the connected two or more electronic devices with one of the generated display windows.

At block 805, the control module controls the display screen of the display apparatus to display screen images generated from the display image signals sent from each of the connected two or more electronic devices in the generated display windows associated with each of the connected two or more electronic devices.

At block 806, the control module adjusts display styles of the generated display windows in response to user's operation on the generated display windows and user instructions input through an input device of the display apparatus or sent from one of the connected electronic device.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in particular the matters of shape, size, and arrangement of parts within the principles of the present disclosure, up to and including the full extent established by the broad general meaning of the terms used in the claims.

What is claimed is:

1. A display apparatus for displaying screen images from multiple electronic devices, the display apparatus comprising:
a display screen;
a connection device connected to the display screen and connectable to the multiple electronic devices;
at least one processor; and
a storage device storing one or more programs, which when executed by the at least one processor, cause the at least one processor to:
establish connections between the connection device and two or more of the multiple electronic devices when the connection device receives connection requests from two or more of the multiple electronic devices;
control the connection device to receive screen image signals sent from the connected two or more electronic devices;
generate a plurality of display windows on a display area of the display screen;
associate each of the connected two or more electronic devices with one of the plurality of generated display windows; and
display screen images generated from the display image signals sent from each of the connected two or more electronic devices in the generated display windows associated with each of the connected two or more electronic devices.

2. The display apparatus as described in claim 1, wherein the connection device is a wireless communication device which comprises a plurality of wireless transmission components which are capable of transmitting and receiving different types of wireless signals, wherein each of the wireless transmission components are configured to communicate with one or more of the multiple electronic devices which are capable of transmitting the same type of wireless signal.

3. The display apparatus as described in claim 1, wherein the at least one processor determines the total of the generated display windows based on the total of the connected electronic devices.

4. The display apparatus as described in claim 1, wherein the at least one processor determines the total of the generated display windows based on an input number.

5. The display apparatus as described in claim 1, wherein the at least one processor further adjusts display styles of the plurality of generated display windows in response to user's operation on the generated display windows and user instructions input through an input device of the display apparatus or sent from one of the connected electronic device.

6. The display apparatus as described in claim 5, wherein when one of the plurality of generated display windows is selected and a full-screen display instruction is received, the at least one processor further enlarges the selected display window to cover the whole display area of the display screen, and minimizes or hides the other generated display windows.

7. The display apparatus as described in claim 5, wherein when one of the plurality of generated display windows is selected and an enlarged display instruction is received, the at least one processor further reduces all of the plurality of generated display windows, and generates a main display window covering most of the display area of the display screen, wherein the main display window is configured to display the screen image in the selected display window.

8. A computer-based method for displaying screen images from multiple electronic devices using a display apparatus, the method comprising:
establishing connections between a connection device of the display apparatus and two or more of the multiple electronic devices when the connection device receives connection requests from two or more of the multiple electronic devices;
controlling the connection device to receive screen image signals sent from the connected two or more electronic devices;
generating a plurality of display windows on a display area of a display screen of the display apparatus;
associating each of the connected two or more electronic devices with one of the plurality of generated display windows; and
displaying screen images generated from the display image signals sent from each of the connected two or more electronic devices in the generated display windows associated with each of the connected two or more electronic devices.

9. The method as described in claim 8, further comprising:
adjusting display styles of the plurality of generated display windows in response to user's operation on the generated display windows and user instructions input through an input device of the display apparatus or sent from one of the connected electronic device.

10. The method as described in claim 9, further comprising:
upon one of the plurality of generated display windows being selected and a full-screen display instruction being received, enlarging the selected display window to cover the whole display area of the display screen, and minimizing or hiding the other generated display windows.

11. The method as described in claim 9, further comprising:
upon one of the plurality of generated display windows being selected and an enlarged display instruction is received, reducing all of the plurality of generated display windows, and generating a main display window covering most of the display area of the display screen, wherein the main display window is configured to display the screen image displayed in the selected display window.

12. A non-transitory computer-readable medium having stored thereon instructions that, when executed by at least one processor of a display apparatus, causing the display apparatus to perform a method for displaying screen images from multiple electronic devices, the method comprising:
establishing connections between a connection device of the display apparatus and two or more of the multiple electronic devices when the connection device receives connection requests from two or more of the multiple electronic devices;
controlling the connection device to receive screen image signals sent from the connected two or more electronic devices;
generating a plurality of display windows on a display area of a display screen of the display apparatus;
associating each of the connected two or more electronic devices with one of the plurality of generated display windows; and
displaying screen images generated from the display image signals sent from each of the connected two or more electronic devices in the generated display windows associated with each of the connected two or more electronic devices.

13. The non-transitory computer-readable medium as described in claim 12, wherein the method further comprising:
adjusting display styles of the plurality of generated display windows in response to user's operation on the generated display windows and user instructions input through an input device of the display apparatus or sent from one of the connected electronic device.

14. The non-transitory computer-readable medium as described in claim 13, wherein the method further comprising:
upon one of the plurality of generated display windows being selected and a full-screen display instruction being received, enlarging the selected display window to cover the whole display area of the display screen, and minimizing or hiding the other generated display windows.

15. The non-transitory computer-readable medium as described in claim 13, wherein the method further comprising:
upon one of the plurality of generated display windows being selected and an enlarged display instruction is received, reducing all of the plurality of generated display windows, and generating a main display window covering most of the display area of the display screen, wherein the main display window is configured to display the screen image displayed in the selected display window.
